(19) United States
(12) Patent Application Publication
(10) Pub. No.: US 2026/0291421 A1
(43) Pub. Date: Sep. 24, 2026

(54) ELECTRONIC CONTROL UNIT FOR CONTROLLING AN ACTUATOR AND SYSTEM COMPRISING THE ELECTRONIC CONTROL UNIT

(71) Applicant: Webasto SE, Stockdorf (DE)

(72) Inventor: Andreas Maier, Stockdorf (DE)

(21) Appl. No.: 19/573,924

(22) Filed: Mar. 20, 2026

(30) Foreign Application Priority Data
Mar. 21, 2025 (DE) 102025111058.1

(51) Int. Cl. H02P 23/00; B60W 60/00

(52) U.S. Cl. CPC H02P 23/00; B60W 60/001; B60W 2420/408

(57) ABSTRACT

An electronic control unit for controlling an actuator in a vehicle comprises a digital first interface that can be connected to a digital data bus in order to receive signals from at least one other bus participant that are used to request operation of the actuator, and at least one second interface that connects the electronic control unit to a motor unit of the actuator in order to control a motor of the motor unit on the basis of signals transmitted via the second interface.

### CROSS-REFERENCE TO RELATED APPLICATION

This application claims priority to German Application No. DE 102025111058.1 filed on Mar. 21, 2025, which is incorporated herein by reference in its entirety for all purposes.

### TECHNICAL FIELD

The invention relates to an electronic control unit for controlling an actuator, in particular an actuator that is used to move a sensor into an operating position. The invention also relates to the field of autonomous driving of vehicles.

### BACKGROUND

In recent years, continuous progress has been made in the field of automating the driving of vehicles, in particular motor vehicles, heavy goods vehicles, special vehicles and construction machinery. In accordance with the international standard SAE J3016 from the organization SAE-International, levels are defined that classify the degree of automation for a given vehicle design. The distinctions made here are between level 0 (human self-driver), level 1 (assisted mode: individual functions), level 2 (assisted mode: partial automation), level 3 (automated mode: no continuous driver monitoring), level 4 (autonomous mode: driver monitoring only as requested) and level 5 (autonomous mode: full automation, no driver required). Level 4 vehicles are already close to being in a practical and marketable condition.

Autonomous driving is made possible by all-round monitoring of the vehicle by sensors and cameras, based on different technologies. Most of the sensors used in systems for autonomous driving are installed so that they are fixed, and are usually not mechanically retracted and extended. Their placement and construction are configured so that they work in an optimum manner without the need for adjustment. There are also systems for detecting the autonomous driving environment, which are integrated in the most appropriate region of the vehicle for this purpose, namely the roof of the vehicle. This firstly provides the highest possible location on the vehicle, which affords the best all-round visibility, and secondly ensures the best protection against soiling of or damage to the components, some of which are sensitive. In addition, the car roof provides for a compact, enclosed arrangement of the system with components situated close to each other, making cabling less complex.

For example, the following components are used in a system of this kind: LIDAR sensors, radar sensors, cameras for autonomous driving or, where applicable, ultrasonic sensors. As described, these components are conventionally installed so that they are fixed and immobile.

LIDAR sensors (Light Imaging, Detection A nd Ranging) are often located on the roof of the vehicles to allow 360-degree vision or detection. The technology behind LIDAR requires clear visibility in all directions, which is ensured by fixed installation on the roof. Designs for retractable and extendable LIDAR systems are available to improve aerodynamics or protect the system when not in use, but systems of this kind are rather the exception in practice. However, when the system is placed in the car roof, functions of this kind are quite desirable.

Permanent installation of the sensors ensures that the systems are constantly available for autonomous driving. Mechanically retractable and extendable systems are more complex, more prone to failure, and may require regular maintenance. Autonomous vehicles are configured to be able to use their sensors at any time to ensure safe navigation. Nevertheless, as described, there is an increasing need to design sensors of this kind so that they can be moved in order to be able to incorporate them into the design of the vehicle and yet exploit the full functionality.

In examples of autonomous driving sensor systems integrated in a vehicle roof, an appropriate motor function for extending and retracting sensors from the body must be configured in accordance with defined safety objectives. If the vehicle has suitable redundancy for the sensor function, the individual functions only need to be classified in the ASIL (Automobile Safety Integrity Level, according to the safety standard ISO-26262) B class, for example. This means, for example, that, when open due to a malfunction the sensor must not leave the lift position while the vehicle is in the autonomous driving mode via the associated sensors (lidar, camera, etc.). Among other things, BDLC (Brushless Direct Current Motor) motors are provided for the sensor lift function, as they offer some advantages over standard DC motors, for example in terms of the controllability of the motor position or the feedback of status information by motor-internal sensors. Advantages also include, for example, better behaviour with regard to electromagnetic compatibility, a longer service life (no brushes), or lower weight, etc. Compared to DC motors, however, BDLC motors require complex open-loop and closed-loop control electronics, which, according to defined safety objectives, must comply with at least ASIL B, for example. However, other types of motor are also possible in principle.

In order to quantify or classify the requirements that exist in each case, the safety standard ISO-26262 is divided into appropriate classes from the lowest requirement "QM" (Quality Management, i.e. non-safety-related), through "ASIL A", "ASIL B", "ASIL C" up to the highest requirement "ASIL D". These are determined by characterizing each possible hazardous state using three parameters. These are: the severity of a possible injury that may occur during a vehicle event (from S0 without injury to S3 with serious or fatal injury), the exposure to or foreseeable frequency of driving conditions under which injuries may occur (from E0 (with a probability of almost zero) or very low E1 (injuries occur only under rare driving conditions) up to a high probability of E4 (occurrence of injuries under the given driving conditions certain)), and also controllability, i.e. the probability of the driver being able to act or deal with the issue to control the situation and avoid injury (from the controllable state C0 to the uncontrollable state C3).

The relevant ASIL levels A, B, C or D then determine the requirements for the product or subassembly or component that is to be developed. The given numbers of a combination (e.g. the triple S2/E3/C3) produce a summand (here 2+3+3=8). For example, ASIL B corresponds to the summand "8".

In the case of the extendable and retractable sensor, in particular the LIDAR sensor, the ASIL B class is generally required, i.e. the system must be compatible with the requirements set out in ASIL B. In this case, this extends to the relevant subassembly with the control unit and the actuator with the motor, gear unit and mechanism.

Market research has shown that it is relatively difficult and time-consuming to find suppliers who offer suitable and already available BDLC motors and corresponding control electronics that firstly meet general customer requirements and automotive standards and secondly cover requirements relating specifically to sensor modules, in particular those in the roof of a vehicle. Further compatibility with safety requirements according to the ASIL B or higher (i.e. ASIL-C or ASIL-D) class for products of this kind is another challenge. A suitable BDLC motor solution for a sensor module therefore regularly involves financing a new motor and control electronics development, which can mean considerable expenditure in terms of cost and time for the project or product.

### SUMMARY

The object is to resolve the aforementioned problems, in particular to save costs and at the same time ensure the safety of the system against failure or faults.

According to one aspect, an electronic control unit for controlling an actuator in a vehicle is proposed, the electronic control unit comprising a digital first interface and at least one second interface. The digital first interface is configured to be able to be connected to a digital data bus in order to receive signals from at least one other bus participant that are able to be used to request operation of the actuator. The at least one second interface connects the electronic control unit to a motor unit of the actuator in order to control a motor of the motor unit on the basis of signals transmitted via the second interface. In this respect, the electronic control unit is equipped with conventional means of communication and control to allow the desired operation of the actuator by way of the motor control.

The electronic control unit is additionally configured to optionally isolate the motor unit from a power supply source of the vehicle. Such isolation allows the motor unit as a whole and the motor of the motor unit in particular to be switched off and de-energized. In any fault situation within the general scope of the invention, this allows for example a sensor, or a sensor module comprising said sensor, to be prevented from being actively retracted by the actuator in question. This may be important if, for example, a vehicle in the autonomous driving mode of operation is still moving and continuous detection of the environment is required even if the fault persists. This is assuming that the sensor (or the electronic component) is still operational in the event of a fault.

The actuator is understood here to mean the combination of a motor unit and its associated gear unit. However, the component moved by the actuator may, but over the full range of the scope described here does not necessarily have to, be a sensor module. This may e.g. also entail a design comprising a signal-transmitting element (light, radiation in other wavelengths, reflectors) that, for example, can also be used for autonomous driving. Other types of movable components are also possible. The term "sensor" in the present case refers e.g. to LIDAR sensors, radar sensors, cameras for autonomous driving or, where applicable, also ultrasonic sensors or the like. These sensors may be configured to emit radiation or waves (e.g. sound waves) and then receive reflected waves. A sensor can comprise an emitter (transmitter) and a receiver (detector), or can also comprise just a receiver (detector).

The term "sensor module" used here comprises the actual sensor, including associated electronics with connections, and a (movable) mechanical holder for the sensor. A sensor module can also comprise two or more sensors. The sensor module comprising the sensor (or another element) is the component actually moved, e.g. extended and retracted, by the actuator.

The proposed electronic control unit still allows the critical safety requirements for handling fault situations to extend to the electronic control unit itself, but no longer to the motor unit. This is because the latter can be switched to a passive state by the isolation, while the function of the component that it otherwise moves is maintained. This shift in the extent of the security requirements may, for example, result in the electronic control unit needing to be developed and configured as a first unit in the design according to ASIL B (or ASIL C or ASIL D, depending on the higher-level application, e.g. one of the aforementioned level 1, 2, 3, 4 or 5 degrees of automation), whereas the motor unit now needs to be developed and configured only according to the class QM.

As a result, development costs are significantly reduced and conventionally available motor units may certainly also be used where applicable.

According to one exemplary embodiment, the electronic control unit may further comprise a first power input and a power output. The first power input can have a line connected to it that is connected to the power supply source and provides a predetermined operating voltage. According to other exemplary embodiments, this operating voltage may include a DC voltage of 6 volts or more and 60 volts or less, in particular 9 volts or more and/or of 16 volts or less, or substantially 24 volts or substantially 48 volts. However, other voltage ranges, e.g. in the high voltage range, or even an AC voltage, are also possible in principle.

In the exemplary embodiment, said power output can be connected to a second power input of the motor unit in order to connect the motor unit to the power supply source, so that the motor can be supplied with the operating voltage via an electrical connection between the first power input and the power output. In other words, the electronic control unit is configured to optionally loop through the operating voltage provided by the power supply source to the motor unit. This is a compact design for the electronic control unit. The power supply can be isolated internally.

According to one development, the electronic control unit comprises a switch unit comprising one or more switches that can be optionally closed or opened in order to make or break the electrical connection between the first power input and the power output. The switch or switches may be e.g. a semiconductor switch, preferably an IGBT or a power MOSFET. The electronic control unit may comprise e.g. a printed circuit board fitted with electronic components, the switch or switches being provided as a separate component on the printed circuit board, or as a component integrated in a semiconductor substrate (IC). Furthermore, the switch or switches can switch not only the supply with positive operating voltage but also the supply with negative operating voltage or earth potential.

According to another exemplary embodiment, the electronic control unit may be configured to detect a mode of operation of the vehicle. Preferably, the mode of operation can be detected by way of information, for example responses to queries, messages or commands in the form of signals, that is obtained by the electronic control unit from one or more other bus participants via the digital data bus. The electronic control unit may have one or more central control units that receive and evaluate these signals and break the electrical connection depending on the detected mode of operation of the vehicle. The mode of operation can be e.g. a currently activated function of one or more sensors (i.e. cameras, LIDAR sensors, ultrasonic sensors, radar sensors, etc.). The mode of operation can also generally include the activation of autonomous driving.

For example, the actuator comprising the motor unit may be configured to move a sensor, in particular a sensor module comprising a camera, a LIDAR sensor, a radar sensor or an ultrasonic sensor or the like, from a rest position to an operating position and vice versa when the detected mode of operation is an autonomous, driverless driving mode of the vehicle.

According to exemplary embodiments, the electronic control unit's at least one second interface that connects the electronic control unit to a motor unit of the actuator may be a digital second interface that can be connected to a further digital data bus, to which a third interface of the motor unit is connected as another bus participant. The further digital bus may preferably be a LIN bus, a CAN bus or similarly suitable bus also being possible. The digital second interface is accordingly configured to convert the transfer of information into the relevant protocol.

This design allows e.g. the operation of a brushless DC motor (BLDC motor) or the control of a motor of this kind by the electronic control unit. In this case, the advantages that can be achieved by the invention become particularly clear. The BLDC motor has its own control electronics, which include e.g. the actual control device and a sensor system (e.g. Hall sensors). An inherent requirement of this design would be that in an environment with increased safety requirements, as in the case of the operation of sensors for fully or partially autonomous driving, said safety requirements also extend to the BLDC motor and in particular its control electronics. Conventionally, this would lead to higher development and parts costs (BOM – bill-of-material). Due to aspects of the invention, however, the BLDC motor is now switched off, in particular in the event of a fault, so that only the requirements according to conventional quality management (QM) now need to be met in this case.

Nevertheless, according to exemplary embodiments, the other case may also be covered by aspects of the invention, namely when the motor is operated using analogue signals. In this case, the at least one second interface that connects the electronic control unit to a motor unit of the actuator may be, in each case, an analogue second interface connected to a corresponding analogue motor interface by way of one analogue signal line each.

In this case, the second interface may be configured in such a way that it is used to transmit pulse-width-modulated control signals to the motor unit to operate the motor of the motor unit. Alternatively or additionally, the second interface may be configured in such a way that it is used to transmit analogue signals that affect the direction of rotation of the motor. More alternatively or additionally, the second interface may be configured in such a way that it is used to receive sensor signals from a sensor, in particular a Hall sensor, that detects the rotational position of the motor. The control of the motor is ultimately undertaken by the electronic control unit itself according to these exemplary embodiments.

Other aspects provide a system that comprises both the electronic control unit as described in accordance with one or more of the exemplary embodiments above and the corresponding motor unit for the complete actuator. The actuator that moves the sensor module (or in general the component module) may further have a mechanism or cam control means in such a way that said mechanism or cam control means defines an end position for the sensor module (component module). This end position represents a state in which the sensor module (component module) is in the active, operational, extended mode. According to exemplary embodiments, the mechanism or cam control means is configured in such a way that forces that act on the sensor module (component module) from the outside (acceleration or braking forces, its own weight, etc.) do not result in any change of position of the sensor module. For example, a cam track may be configured or extend such that in the end position forces of this kind act on a sliding block perpendicular to the cam track. Only a gradual movement of the motor could then allow a section of the cam track to be reached in which forces acting from the outside also work with or against the motor. However, since the motor and also its control electronics, as described above, are, according to exemplary embodiments, possibly switched off in the end position of the sensor module (component module), and forces do not have any effect there, this results in ensured, unalterable positioning of the sensor module (component module) being achieved. This design completes possible ASIL B compliance of the system, in which the motor unit only needs to meet QM requirements.

According to a particularly advantageous system development, the motor of the motor unit may be a brushless DC motor (BLDC). The advantages are the same as described above.

Further embodiments of the invention result from the appended dependent claims.

### BRIEF DESCRIPTION OF THE DRAWINGS

Exemplary embodiments of the invention will be explained in more detail below with reference to the drawings, in which:

FIG. 1 uses a schematic block diagram to show a design of a system for controlling an actuator in a vehicle according to a first exemplary embodiment;

FIG. 2 uses a schematic block diagram to show a design of a system for controlling an actuator in a vehicle according to a second exemplary embodiment;

FIG. 3 uses a schematic block diagram to show a design of a system for controlling an actuator in a vehicle according to an embodiment from the prior art;

FIG. 4 shows an overview of a roof sensor module arrangement.

### DETAILED DESCRIPTION

In the description of a preferred exemplary embodiment that follows, it should be taken into consideration that the present disclosure of the various aspects is not limited to the details of the design and the arrangement of the components as illustrated in the description below and in the figures. The exemplary embodiment can be implemented or carried out in various ways in practice. It should also be taken into consideration that the wording and terminology used here is used merely for the purpose of the specific description and should not be interpreted restrictively as such by a person skilled in the art. In addition, in the description below, the same reference signs in the exemplary embodiment or the figures denote identical or similar features or objects, and therefore in some cases a repeated detailed description of them is omitted in order to maintain the compactness and clarity of the illustration.

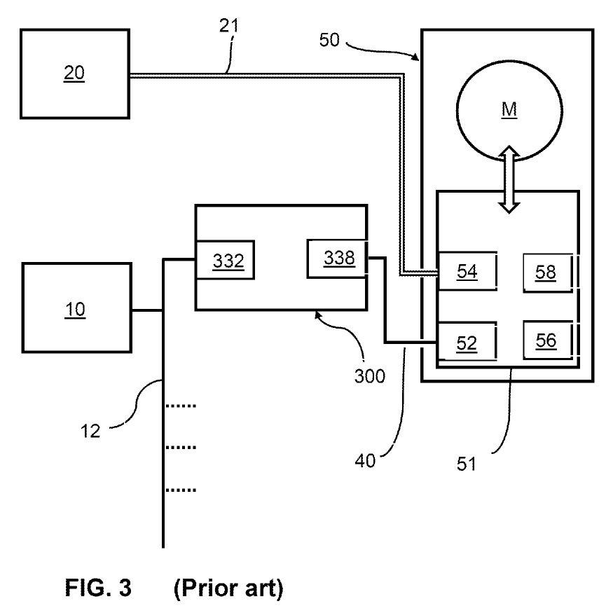

FIG. 3 first uses a schematic block diagram to show a design of a system for controlling an actuator in a vehicle according to the prior art. The actuator to be controlled comprises a motor unit 50, which comprises the actual motor M with the rotor and the stator and control electronics 51. This is a BLDC motor. The control electronics 51 have a central control device 56, which undertakes tasks for controlling the motor M, and a sensor system 58, which is shown here only very schematically. The sensor system comprises, for example, Hall sensors that can be used to determine the motor position and speed, temperature sensors that permit safety measures when a temperature is exceeded, and voltage or current measurement to allow a power consumption to be determined. Based on these acquired data, the motor can be controlled in a specific manner by the central control device 56.

For this purpose, the motor unit 50, i.e. the motor M and the control electronics 51, is supplied with electrical power from a power supply source 20 via a line 21 and, to this end, has a power connection 54. In the exemplary embodiment, this may entail a power supply via a KL30 connection (9 – 16 volts).

Higher-level control of the operation of the motor unit 50 is undertaken by an electronic control unit 300, which is connected to other bus participants 10 by way of a first digital interface 332 and a first digital bus 12, here a CAN bus. The first digital bus 12 is a vehicle bus.

The electronic control unit 300 is connected to a third digital interface 52 of the control electronics 51 of the motor unit 50 by a second digital interface 338 and a second digital bus 40. This second digital bus 40, which may be, for example, a LIN bus, can be used by the electronic control unit 300 to send messages to the control electronics 51 regarding e.g. an activation per se, a target position to be moved to or the like, or also to transmit status requests, etc., and to receive corresponding responses.

If there are safety requirements according to ASIL-B, these requirements must be met both by the electronic control unit 300 and by the BLDC motor (motor unit 50).

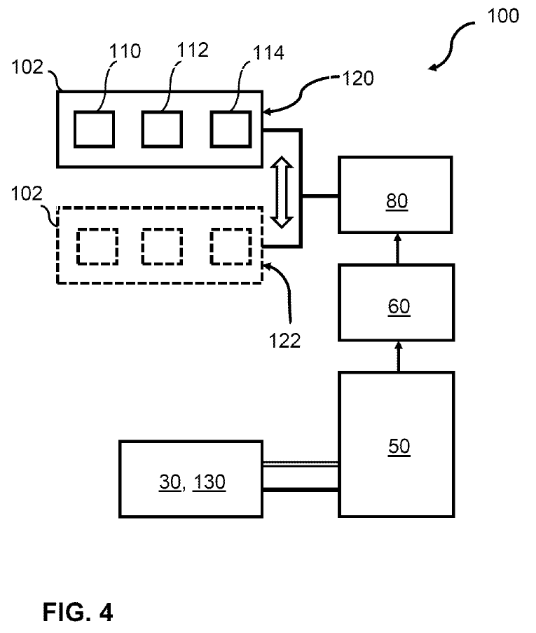

An implementation of the system in a roof sensor module arrangement 110 is shown in FIG. 4. Details of the power supply and the buses are omitted here for the sake of simplicity. FIG. 4 also includes elements of the exemplary embodiments that will be described below.

The motor unit 50 exerts the motive force (rotation) generated by it on a gear unit 60, which transforms the rotation e.g. into a linear motion. A cam control means 80 (mechanism) is used to transfer this motion to a sensor module 102 that is e.g. set up on a vehicle roof in the form of a retractable and extendable flap and comprises a number of sensors, in the example LIDAR sensors 110, radar sensors 112 and cameras 114. The cam control means 80 acts like a cam and a cam follower. In this way, the drive of the motor allows the sensor module 102 to be moved between a retracted position 122 and an extended end position 124.

In one exemplary embodiment of the invention, as illustrated in FIG. 4, the cam control means 80 is such that it brings about locking when the motor is no longer operational. The action of external forces then no longer changes the position of the sensor module 102, in particular if the motor M and the control electronics 51 are switched off. This design of the cam control means can be brought about purely mechanically by a suitable geometry of the cam track. The use of further Hall or mechanical sensors and switches for operating a locking mechanism is also possible, however.

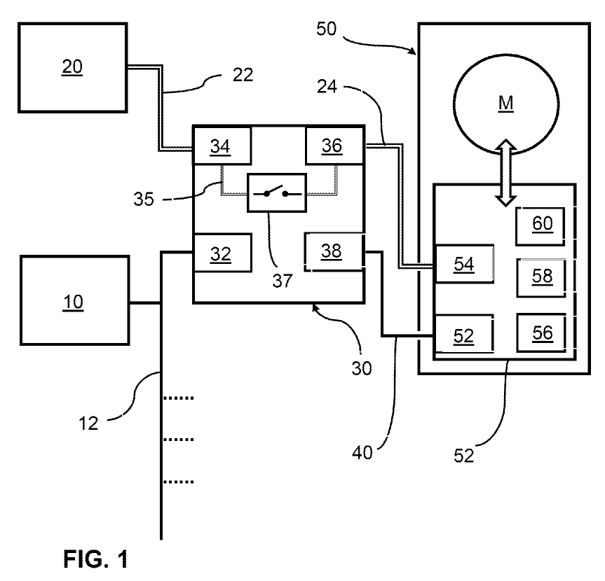

FIG. 1 uses a schematic block diagram to show a design of a system for controlling an actuator in a vehicle according to a first exemplary embodiment. Here too, the motor unit 50 is a BLDC motor. The motor unit 50 may be identical to that shown in FIG. 3. Only the differences in relation to FIG. 4 are described.

An electronic control unit 30 according to one exemplary embodiment is provided here, which electronic control unit also again has a digital first interface 32 and a digital second interface 38 that undertake the communication via the corresponding digital bus systems 12, 40 as described with reference to FIG. 3 (bus 12 is e.g. a CAN bus, bus 40 is e.g. a LIN bus). However, the conventionally direct line 21 between the power supply source 20 and the motor unit 50 is split into two line sections 22, 24 here. In particular, the electronic control unit 30 is configured to loop through the power supply for the motor unit 50. To this end, the electronic control unit 30 has a first power input 34 and a power output 36, which in turn is connected to the second power input 54 of the motor unit 50 by way of the second line section 24. The first power input, on the other hand, is connected to the power supply source 20 by way of the first line section 22.

The electronic control unit 30 is provided with a switch unit 37 connected between the first power input 34 and the power output. The electronic control unit 30 has, for example, a central control unit (not shown) that can use the first digital bus 12 and the digital first interface to receive information, or a message, that communicates a current autonomous driving mode of operation for the vehicle. Furthermore, this channel can also be used to report a fault. Depending on the detected mode of operation and, where applicable, the fault, the central control unit can operate the switch unit 37 to switch off the motor unit 50. The motor M and the control electronics 51 are thus switched off.

In this case, the sensor module 102 shown in FIG. 4 is secured or locked in the extended end position 120 and can no longer move even with the motor switched off.

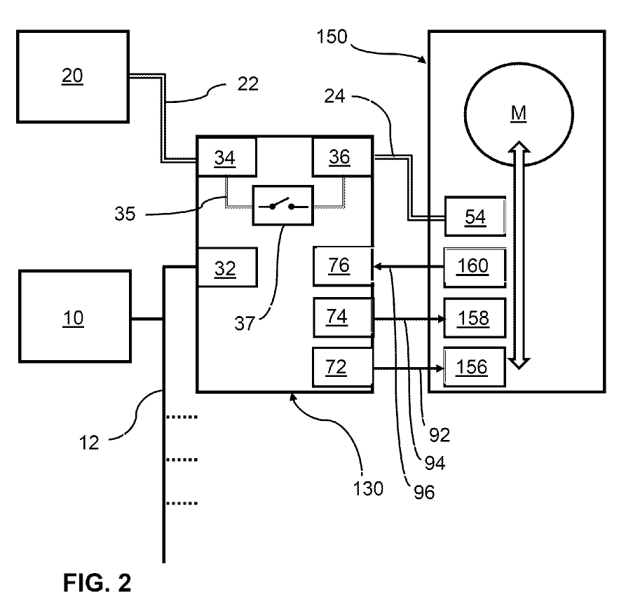

FIG. 2 shows a modification to FIG. 1. The motor M of a motor unit 150 is no longer a BLDC motor here and is instead operated by the electronic control unit 130 using analogue signals. This is accomplished using an analogue second interface, 72, 74, 76, comprising interface portions for a PWM signal generated by the electronic control unit, a direction signal and for sensor signals. A signal line 92 for PWM signals, a signal line 94 for the direction signal and a signal line 96 for the sensor signals connect the second analogue interface to an analogue third interface 156 – 160.

### LIST OF REFERENCE SIGNS

10 further bus participants

12 first digital bus (e.g. CAN bus)

20 power supply source

21 line (power supply)

22 line section (power supply)

24 line section (power supply)

30, 130 electronic control unit, ECU

32 digital first interface

34 first power input

35 electrical connection (power supply)

36 power output

37 switch unit

38 digital second interface

40 second digital bus (e.g. LIN bus)

50, 150 motor unit

51 control electronics

52 digital third interface

54 power connection

56 central control unit

58 sensor system (incl. Hall sensors)

60 gear unit

72-76 analogue second interface

72 …for PWM signal

74 …direction signal

76 …for sensor signals

80 cam control means

92 signal line (PWM signals)

94 signal line (direction signal)

96 signal line (sensor signals)

156-160 analogue third interface

100 roof sensor module arrangement

102 sensor module

110 LIDAR sensor

112 radar sensor

114 camera

120 extended end position

122 retracted position

300 electronic control unit, ECU (prior art)

332 first digital interface

338 second digital interface

M motor

1. An electronic control unit for controlling an actuator in a vehicle, comprising:
a digital first interface which is configured to be connected to a digital data bus in order to receive signals from at least one other bus participant that are used to request operation of the actuator; and
at least one second interface which is configured to connect the electronic control unit to a motor unit of the actuator in order to control a motor of the motor unit on the basis of signals transmitted via the second interface;
wherein the electronic control unit is additionally configured to isolate the motor unit from a power supply source of the vehicle.

2. The electronic control unit according to claim 1, further comprising:
a first power input, to which a line that is connected to the power supply source and provides a predetermined operating voltage is configured to be connected; and
a power output which is configured to be connected to a second power input of the motor unit in order to connect the motor unit to the power supply source, so that the motor can be supplied with the operating voltage via an electrical connection between the first power input and the power output.

3. The electronic control unit according to claim 2, further comprising:
a switch unit comprising at least one switch that can be closed or opened in order to make or break the electrical connection between the first power input and the power output.

4. The electronic control unit according to claim 3,
Wherein the electronic control unit is configured to detect a mode of operation of the vehicle, by way of at least one of: commands and information obtained in the form of signals via the digital data bus from one or more other bus participants, and to break the electrical connection depending on the detected mode of operation of the vehicle.

5. The electronic control unit according to claim 4,
wherein the actuator that comprises the motor unit is configured to move a LIDAR sensor, from a rest position to an operating position and vice versa, and
wherein the detected mode of operation is an autonomous, driverless driving mode of the vehicle.

6. The electronic control unit according to claim 1,
wherein the power supply source is configured to provide a DC voltage of at least one of: 9 volts or more and 16 volts or less as the operating voltage.

7. The electronic control unit according to claim 1,
wherein the at least one second interface that connects the electronic control unit to a motor unit of the actuator is a digital second interface that is configured to be connected to a further digital data bus, to which a third interface of the motor unit is connected as another bus participant.

8. The electronic control unit according to claim 1,
wherein the at least one second interface that connects the electronic control unit to a motor unit of the actuator is, in each case, an analogue second interface connected to a corresponding analogue motor interface by way of one analogue signal line each.

9. The electronic control unit according to claim 8, wherein at least one of:
a second interface of the at least one second interface is configured in such a way that it is used to transmit pulse-width-modulated control signals to the motor unit to operate the motor;
a second interface of the at least one second interface is configured in such a way that it is used to transmit analogue signals that affect the direction of rotation of the motor; and
a second interface of the at least one second interface is configured in such a way that it is used to receive sensor signals from a Hall sensor, that detects the rotational position of the motor.

10. A system comprising an electronic control unit and a corresponding motor unit,
wherein the electronic control unit comprises:
a digital first interface which is configured to be connected to a digital data bus in order to receive signals from at least one other bus participant that are used to request operation of the actuator; and
at least one second interface which is configured to connect the electronic control unit to the motor unit of the actuator in order to control a motor of the motor unit on the basis of signals transmitted via the second interface;
wherein the electronic control unit is additionally configured to isolate the motor unit from a power supply source of the vehicle.

11. The system according to claim 10, wherein the motor of the motor unit is a brushless DC motor (BLDC).

12. The system according to claim 10, wherein the actuator that comprises the motor unit is configured to move a LIDAR sensor from a rest position to an operating position and vice versa, and
wherein the actuator comprises or is connected to, a mechanism or cam control means in such a way that the mechanism or cam control means defines an end position for a sensor module carrying the sensor,
wherein this end position represents a state in which the sensor module comprising the sensor is in an active, operational, extended mode, and
wherein the mechanism or cam control means is configured in such a way that the position of the sensor module is locked in the defined end position, wherein forces that act on the sensor module from the outside, in particular acceleration or braking forces or its own weight, except those from the actuator, do not result in any change of position of the sensor module.
